(19) United States
(12) Patent Application Publication
(10) Pub. No.: US 2008/0251705 A1
(43) Pub. Date: Oct. 16, 2008

(54) IMAGE SENSOR CHIP PACKAGE

(75) Inventor: FU-YEN TSENG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/873,235

(22) Filed: Oct. 16, 2007

(30) Foreign Application Priority Data
Apr. 10, 2007 (CN) 200710200418.7

(51) Int. Cl. H01J 5/02

(52) U.S. Cl. 250/239

(57) ABSTRACT

An image sensor chip package includes a base, a sidewall adhered on peripheries of the base, an image sensor chip adhered on a top face of the base, and a cover adhered with the sidewall. The base includes a top face and a bottom face formed on an opposite side to the top face defining a number of outer pads thereon. The sidewall includes a number of inner pads is disposed on the inner side of the sidewall and corresponding to electrically connect with the corresponding outer pads. The inner pads are disposed on the sidewall to make the base become little. Thus, a volume of the image sensor chip package becomes thinner compare with the conventional image sensor chip package.

### TECHNICAL FIELD

The present invention relates to the art of package technology, and particularly, to a small sized image sensor chip package.

### BACKGROUND

Image sensors are widely used in digital camera modules. In order to protect the image sensors from contamination (i.e., from dust or liquid), the image sensors are generally sealed in a structural package.

A typical image sensor chip is shown in FIGS. 6-7. The image sensor chip is constructed to include a base 1, an adhesive 2, and a number of bonding wires 3, a chip 4, a sidewall 5 and a cover 6. The base 1 includes a top surface 7 and a number of pads 9 mounted along the periphery of the top surface 7. The chip 4 includes a number of welding pads 8 electrically connected with the corresponding pads 9 of the base 1 via the bonding wires 3 and is adhered to the top surface 7 of the base 1 by the adhesive 2. The cover 6 is transparent and secured to a top portion of the sidewall 5 via the adhesive 2, thereby hermetically defining a receiving chamber together with the base 1 to receive the chip 4 therein.

In the image sensor chip, the top surface 7 of the base 1 peripherally surrounded by the sidewall 5 must contain the welding pads 8 and the chip 4 together, and sufficient space should be provided between the chip 4 and the sidewall 5 for movement of wire bonding tools used to connect the bonding wires 3 with the welding pads 8 and the pads 9. Therefore, package volume of packaging the chip 4 is a lot larger than that taken up by the chip 4. As such, the image sensor chip is not suitable for slim, compact electronic products.

### SUMMARY

In accordance with an embodiment, an image sensor chip package includes a base, a sidewall adhered along the periphery of the base, an image sensor chip adhered to the base, and a cover adhered to the sidewall. The base includes a top face and a bottom face with a number of outer pads thereon. The sidewall includes a number of inner pads disposed on an inner surface thereof and electrically connected with the corresponding outer pads. The image sensor chip adhered to the top face of the base includes a number of welding pads electrically connected to the corresponding inner pads. Thus, the image sensor chip is electrically connected with the outer pads via the inner pads of the sidewall.

### BRIEF DESCRIPTION OF THE DRAWINGS

The present invention is described in detail hereinafter, by way of example only, through description of a preferred embodiment thereof and with reference to the accompanying drawing in which:

FIG. 1 is a schematic structural view of a base and an image sensor chip disposed thereon according to a first preferred embodiment;

FIG. 2 is a schematic cross-section view of FIG. 1 taken along line II-II;

FIG. 3 is a schematic cross-section view of an image sensor chip package of the first embodiment;

FIG. 4 is a schematic cross-section view of an image sensor chip package according to a second preferred embodiment;

FIG. 5 is a schematic structure view of a base and an image sensor chip disposed thereon of FIG. 4;

FIG. 6 is a schematic cross-section view of a related image sensor chip package; and

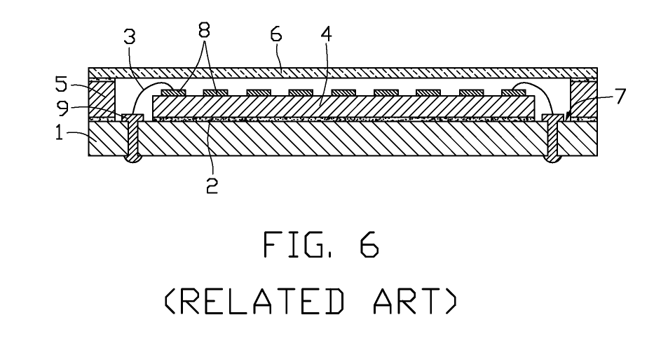

FIG. 7 is a schematic structure view of a base and a chip disposed thereon of FIG. 6.

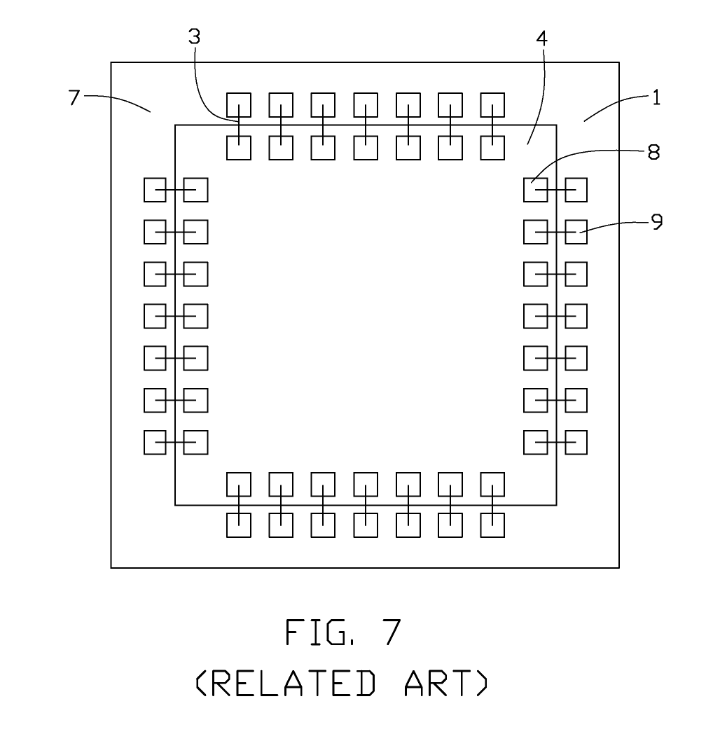

### DETAILED DESCRIPTION OF THE PREFERRED EMBODIMENTS

Embodiments of the present image sensor chip package will now be described in detail below with reference to the drawings.

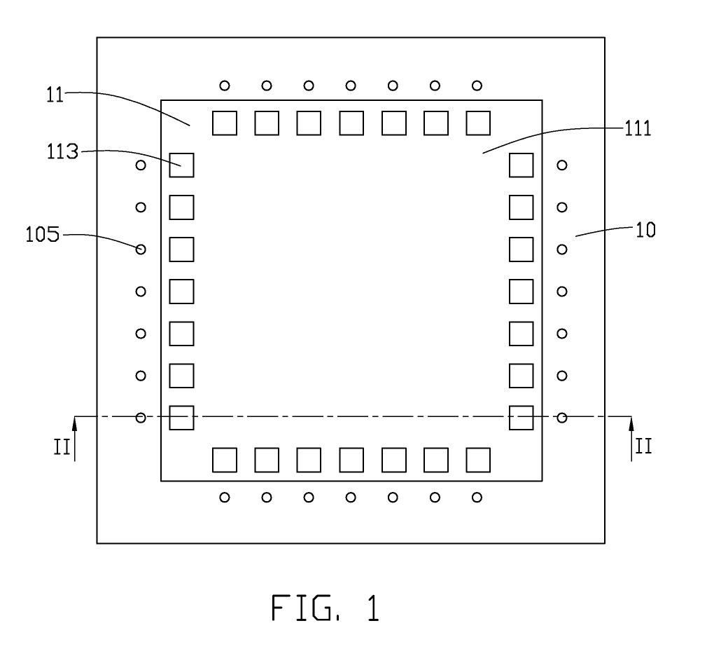

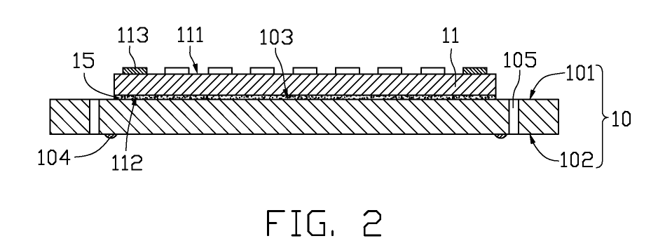

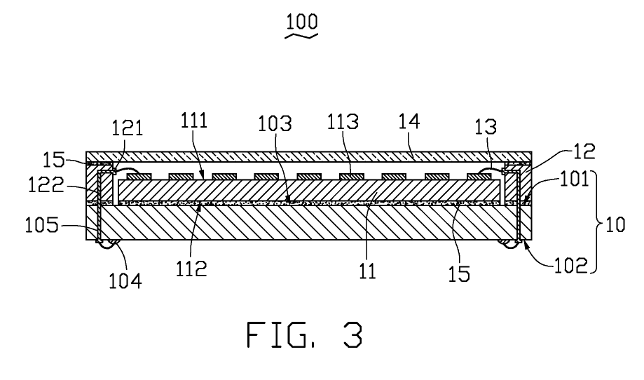

Referring to FIGS. 1-3, an image sensor chip package 100 according to a first preferred embodiment includes a base 10, an image sensor chip 11, a sidewall 12, a number of bonding wires 13, a cover 14, and an adhesive 15. The image sensor chip 11 is mounted on the base 10 via the adhesive 15. The sidewall 12 is mounted along the periphery of the base 10. The cover 14 is attached onto the sidewall 12 via the adhesive 15, covering the base 10 and the image sensor chip 11.

The base 10 is made from a material such as plastic, ceramic, or fiber. The base 10 defines a top face 101, a bottom face 102 formed on an opposite side to the top face 101, a number of outer pads 104 formed on the bottom face 102 and a number of plugholes 105. The plugholes 105 extend through the top and bottom faces 101, 102. The top face 101 has an adhesive area 103 on a middle portion thereof for gluing the image sensor chip 11 thereon. The outer pads 104 are circumferentially arranged on the periphery of the bottom face 102 leaving a usable area of the bottom face 102 for heat dissipation.

The adhesive 15, such as silicone, epoxy, acrylic, or silver colloid, is applied between the image sensor chip 11 and the base 10, and the sidewall 12 and the base 10. The adhesive 15 is also applied between the cover 14 and the sidewall 12. In the first embodiment, the adhesive 15 is silver colloid.

The image sensor chip 11 configured for capturing images has a photosensitive area 111 on a middle portion thereof and a number of welding pads 113 formed therearound for transmitting data captured by the image sensor chip 11. The image sensor chip 11 is adhered to the adhesive area 103 of the top face 101 of the base 10 via the adhesive 15, and surrounded by the plugholes 105.

The sidewall 12 can be made from resin that is bent to form a container with open top and bottom sides. The height of the sidewall 12 is substantially greater than that of the image sensor chip 11. The shape of the sidewall 12 corresponds to that of the base 10. The sidewall 12 is fixed on the top face 101 of the base 10 via the adhesive 15. A number of inner pads 121 is disposed on an inner surface of the sidewall 12 and a number of conductive wires 122 is respectively electrically connected to the corresponding inner pads 121. It can be appreciated that a vertical distance between an upper portion of the inner pad 121 and the base 10 is essentially greater than the height of the image sensor chip 11. Ends of the conductive wires 122 are electrically connected to the inner pads 121 respectively, and the opposite ends of the conductive wires 122 run through the corresponding plugholes 105 to electrically connect to the outer pads 104 of the base 10 via the bonding wires 13. The bonding wires 13 and the welding pads 113 are made from a same material.

The cover 14 can be made of a transparent material, such as glass, lens or transparent resin, and is adhered to a top end of the sidewall 12 via the adhesive 15. Thus, the cover 14 and the sidewall 12, together with the base 10 define a sealed receiving chamber (not labeled) for receiving the image sensor chip 11 therein.

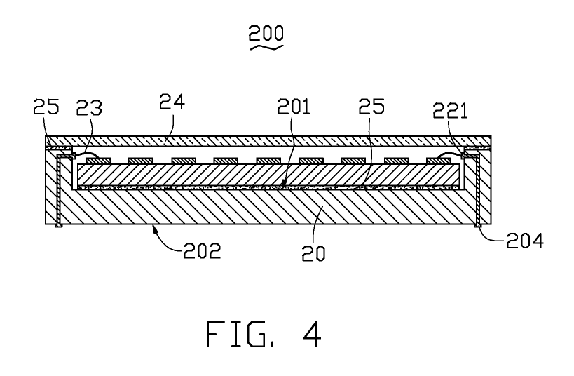

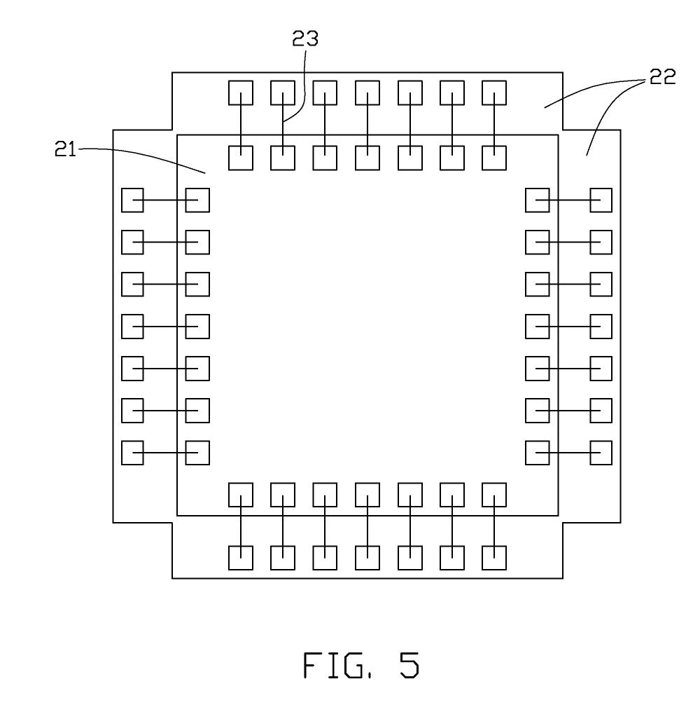

Referring to FIGS. 4-5, an image sensor chip package 200 according to a second preferred embodiment includes a base 20, an image sensor chip 21, a sidewall 22, a number of welding wires 23, a cover 24, and an adhesive 25. The image sensor chip 21 is mounted on the base 20 via the adhesive 25. The sidewall 22 is mounted along the periphery of the base 20, and the cover 24 is attached onto the sidewall 22 via the adhesive 25. The cover 24, the sidewall 22 and the base 20 together define a sealed receiving chamber for receiving the image sensor chip 21 therein.

In the second embodiment, the sidewall 22 is integrated with the base 20. The sidewall 22 can perpendicularly extend upward from a lateral edge of the base 20, or as in this embodiment, firstly extend outward from the lateral edge of the base 20 and fold upward along the edges of base 20. The base 20 includes a top face 201, a bottom face 202 on an opposite side to the top face 201, and a number of outer pads 204 disposed on the bottom face 202.

The sidewall 22 includes a number of inner pads 221 disposed on an inner side thereof. The inner pads 221 are electrically connected to the corresponding outer pads 204. In assembly, the sidewall 22 is perpendicularly folded upward along the edges of base 20 and towards to the image sensor chip 21 adhered on the top face 201 of the base 20. Other configuration, such as bonding the welding wires 23 between the inner pads 221 of the sidewall 22 and the image sensor chip 21, are same as that of the first embodiment. Thus, we don't describe in detail.

Of course, in order to improve the strength of the base 20 and the sidewall 22, a stiff plate (not shown) can be mounted on respective outer sides of the base 20 and the sidewall 22 or an adhesive is filled between the sidewall 22 and the image sensor chip 21. Thus, the sidewall 22 has enough strength to support the cover 24.

As described above, the inner pads are disposed on the sidewall to make the base become small. Thus, the image sensor chip package is compact and a volume of the image sensor chip package becomes thinner compare with the conventional image sensor chip package.

It can be understood that the above-described embodiment are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. An image sensor chip package comprising:
a base comprising a top face, a bottom face formed on an opposite side to the top face and a plurality of outer pads arranged on the bottom face;
a sidewall disposed on peripheries of the top face and comprising a plurality of inner pads disposed on an inner surface of the sidewall and electrically connected to the corresponding outer pads; and
an image sensor chip mounted on the top face and comprising a plurality of welding pads electrically connected to the corresponding inner pads.

2. The image sensor chip package as claimed in claim 1, wherein the sidewall is integrated with the base.

3. The image sensor chip package as claimed in claim 1, wherein the sidewall perpendicularly extends upward from a lateral edge of the base.

4. The image sensor chip package as claimed in claim 1, wherein the sidewall extends outward from a lateral edge of the base and then fold upward to a vertical orientation along the edge of the base and toward to the image sensor chip adhered on the base.

5. The image sensor chip package as claimed in claim 4, wherein both of the base and the sidewall are made from flexible material.

6. The image sensor chip package as claimed in claim 1, wherein a distance between the inner pads and the top face is substantially larger than the height of the image sensor chip.

7. The image sensor chip package as claimed in claim 1, wherein a plurality of conductive wires is embedded in the sidewall, an end of each of the conductive wires is electrically connected to a corresponding inner pad, an opposite end of each of the conductive wires is electrically connected to a corresponding outer pad.

8. The image sensor chip package as claimed in claim 7, wherein the base further comprises a plurality of plugholes, the portion of the conductive wires run through the plugholes respectively.

9. The image sensor chip package as claimed in claim 1, further comprising an adhesive applied between the image sensor chip and the top face of the base.

10. The image sensor chip package as claimed in claim 2, further comprising a cover connected with the sidewall and configured for defining a receiving chamber in which the image sensor chip is received, together with the sidewall and the base.

11. The image sensor chip package as claimed in claim 10, wherein the cover is made of a transparent material.

12. An image sensor chip package comprising:
a base comprising a top face, a bottom face formed on an opposite side to the top face and a plurality of outer pads arranged at the bottom face;
an image sensor chip mounted on the top face of the base and comprising a plurality of welding pads disposed thereat;
a sidewall arranged on a periphery of the top face of the base and surrounding the image sensor chip;
a plurality of inner pads disposed at an inner surface of the sidewall and respectively electrically connected to the welding pads of the image sensor chip via bonding wires;
a plurality of conductive wires embedded in the sidewall and the base to connect the inner pads with the outer pads respectively; and
a cover attached on the sidewall to form a sealed chamber, in which the image sensor chip is received, together with the sidewall and the base.

13. The image sensor chip package as claimed in claim 12, wherein the sidewall and the base are integrally formed.

14. The image sensor chip package as claimed in claim 12, wherein a distance between the inner pads and the top face is substantially greater than the height of the image sensor chip.
